(19) United States
(12) Patent Application Publication
(10) Pub. No.: US 2025/0385437 A1
(43) Pub. Date: Dec. 18, 2025

(54) MULTI-DIAMETER REFLECTOR AND RING THEREFOR AND METHOD OF ASSEMBLING MULTI-DIAMETER REFLECTORS

(71) Applicant: MacDonald, Dettwiler and Associates Corporation, Sainte-Anne-de-Bellevue (CA)

(72) Inventors: Jordan Bellemore, Kirkland (CA); Giuseppe Mennitto, Montreal (CA); Patrick Mottard, St-Lazare (CA); Steven Payette, Pierrefonds (CA)

(21) Appl. No.: 19/236,422

(22) Filed: Jun. 12, 2025

Related U.S. Application Data
(60) Provisional application No. 63/659,424, filed on Jun. 13, 2024.

(51) Int. Cl. H01Q 15/16; H01Q 1/28; H01Q 15/14

(52) U.S. Cl. CPC H01Q 15/166; H01Q 15/141; H01Q 1/288

(57) ABSTRACT

A multi-diameter reflector and a method of assembling the multi-diameter reflector are provided. The reflector includes a reflector shell having a shell diameter, a multi-diameter ring having first and second opposing edges, the multi-diameter ring being structurally adhered to the reflector shell at the first edge, the multi-diameter ring having an outer diameter less than the shell diameter and an inner diameter less than the outer diameter, a panel structurally adhered to the multi-diameter ring at the second edge, the multi-diameter ring having a continuous profile to support structural loads and maintain the reflector shell in a predefined shape.

### TECHNICAL FIELD

The following relates generally to antenna reflectors, and more particularly to multi-diameter rings for antenna reflectors.

### INTRODUCTION

In satellite development and use, providing sufficient stiffness for reflectors is critical to their deployment and use. Where single-ring structures are used to stiffen such reflectors, structural and thermal elastic distortion performance may suffer in the area of the reflector corresponding to an area within (and outside) the single ring or “pocket”.

Accordingly, there is a need for an improved system and method for providing a stiffening support structure to antenna reflectors that overcomes at least some of the disadvantages of existing systems and methods.

### SUMMARY

A multi-diameter reflector is provided, the multi-diameter reflector including a reflector shell having a shell diameter, a multi-diameter ring having first and second opposing edges, the multi-diameter ring being structurally adhered to the reflector shell at the first edge, the multi-diameter ring having an outer diameter less than the shell diameter and an inner diameter less than the outer diameter, and a panel structurally adhered to the multi-diameter ring at the second edge. The multi-diameter ring has a continuous profile to support structural loads and maintain the reflector shell in a predefined shape.

The multi-diameter ring may be a spline.

The multi-diameter ring may include a plurality of bands.

At least one of the plurality of bands may be a spline.

The outer diameter may be 75%-85% of the shell diameter.

The ring may include a plurality of laminates disposed about a honeycomb core.

The ring may be a monolithic laminate.

In an embodiment, the ring includes local reinforcements to increase stiffness or strength.

The local reinforcements may comprise one or more variations in thickness to provide local thicker and thinner sections.

The local reinforcements may comprise one or more doublers.

The ring may be between 1 and 4 inches in height. The outer diameter may be between 25 and 80 inches in diameter.

The ring may include one or more cut-out sections to increase or decrease local flexibility in the ring.

The ring may be structurally adhered to the reflector shell via a continuous bead of permanent adhesive.

A method of assembling a multi-diameter reflector, the reflector including at least one reflector shell sandwich and at least one multi-diameter ring laminate for maintaining stiffness in the at least one reflector shell sandwich, the method including manufacturing a thick panel sandwich, manufacturing the at least one reflector shell sandwich, manufacturing the at least one multi-diameter ring laminate, defining a desired shape of each multi-diameter ring laminate and maintaining the shape by using tooling, dry-fitting and bonding each multi-diameter ring laminate to the thick panel with a structural adhesive, mapping and correcting the shape of the shell to the desired shape by using tooling, and dry-fitting and bonding each shell to a respective multi-diameter ring laminate with structural adhesive.

The thick panel sandwich may include top and bottom carbon-fiber reinforced plastic (CFRP) facesheets with a thickness between 0.040 and 0.060 inches about an aluminum core with a thickness between 2 and 3 inches.

The at least one reflector shell sandwich may include top and bottom CFRP facesheets with a thickness of approximately 0.010 inches about an aluminum or para-aramid core with a thickness of approximately 0.250 inches.

The at least one multi-diameter ring laminate may include a CFRP facesheet with a thickness of approximately 0.040 inches.

Manufacturing the at least one multi-diameter ring laminate may include curing the at least one multi-diameter ring laminate on a mould as a single continuous ring.

Manufacturing the at least one multi-diameter ring laminate may include forming the at least one multi-diameter ring laminate as a single assembly from flat laminate stock bonded together with a structural adhesive.

The at least one multi-diameter ring laminate may be a spline.

The at least one multi-diameter ring laminate may include a plurality of bands.

At least one of the plurality of bands may be a spline.

The at least one multi-diameter ring laminate may include one or more cut-out sections to increase or decrease local flexibility in the at least one multi-diameter ring laminate.

The at least one multi-diameter ring laminate may include local reinforcements to increase stiffness or strength. The local reinforcements may comprise one or more variations in thickness to provide local thicker and thinner sections. The local reinforcements may comprise one or more doublers.

Other aspects and features will become apparent, to those ordinarily skilled in the art, upon review of the following description of some exemplary embodiments.

### BRIEF DESCRIPTION OF THE DRAWINGS

The drawings included herewith are for illustrating various examples of articles, methods, and apparatuses of the present specification. In the drawings:

FIG. 1A is a perspective view of an assembled reflector with a multi-diameter ring, according to an embodiment;

FIG. 1B is a perspective exploded view of the reflector of FIG. 1A;

FIG. 2A is a perspective view of an assembled reflector with a plurality of rings, according to another embodiment;

FIG. 2B is a perspective exploded view of the reflector of FIG. 2A;

FIG. 3 is a flowchart of a method of assembling a multi-diameter reflector, according to an embodiment; and

FIG. 4 is a flowchart of a method of assembling a multi-diameter reflector, according to another embodiment.

### DETAILED DESCRIPTION

Various apparatuses or processes will be described below to provide an example of each claimed embodiment. No embodiment described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatuses described below.

Further, although process steps, method steps, algorithms or the like may be described (in the disclosure and/or in the claims) in a sequential order, such processes, methods and algorithms may be configured to work in alternate orders. In other words, any sequence or order of steps that may be described does not necessarily indicate a requirement that the steps be performed in that order. The steps of processes described herein may be performed in any order that is practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

Throughout the present disclosure, the term “multi-diameter reflector” should be understood to refer to a diameter that includes as a component a “multi-diameter ring” as that term is used herein.

The following relates generally to multi-diameter antenna reflectors, and more particularly to multi-diameter rings for antenna reflectors.

In particular, the present disclosure provides a multi-diameter ring for providing stiffness to a reflector shell to minimize or entirely avoid undesirable behaviour by the shell (e.g., twisting, clamming, cupping, opening up), as well as a method of assembling same. The multi-diameter ring may be used on fixed or deployable antenna reflectors. The reflector may be side-deployable, part of a steerable antenna on a pallet, or fixed to top floor antennas.

The present disclosure may advantageously provide a multi-diameter ring as part of a reflector. The multi-diameter ring may be a single ring or circular or elliptical structure with a plurality of diameters (e.g., a spline). The multi-diameter ring may be a plurality of bands. Each of the plurality of bands may have a single diameter or a plurality of diameters (e.g., one or more of the bands may be a spline).

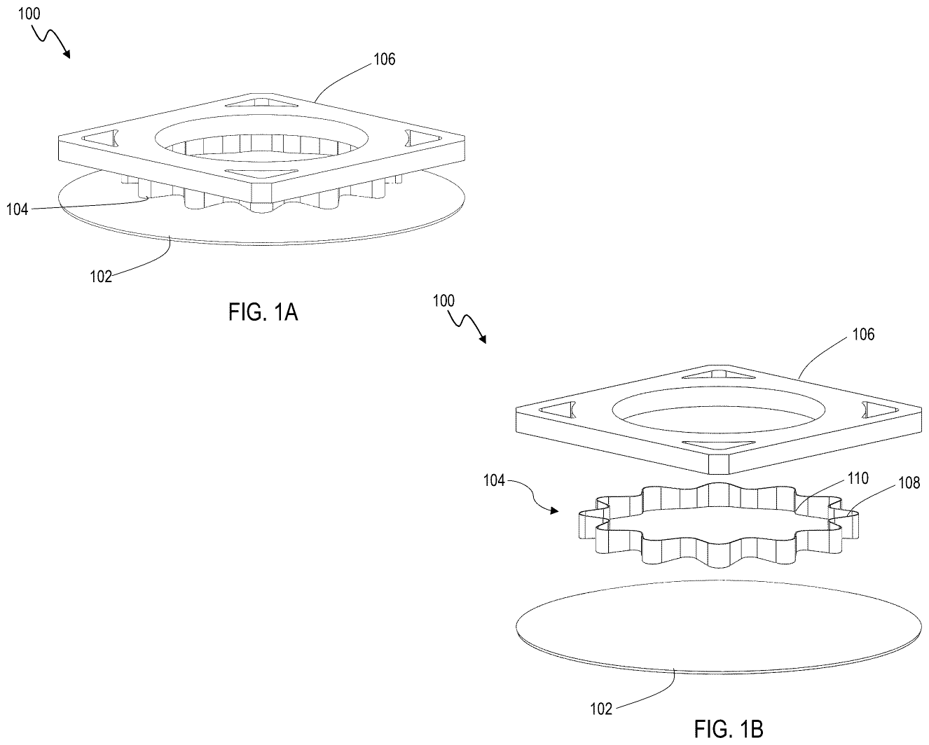

Referring now to FIGS. 1A and 1B, shown therein are a perspective view and a perspective exploded view, respectively, of a reflector 100, including a reflector shell 102, according to an embodiment.

In FIG. 1A, the reflector shell 102 is attached to a ring 104, which is further attached to a panel 106. Accordingly, the reflector shell 102 may be considered to be attached to the panel 106 even though the reflector shell 102 and the panel 106 may not make direct physical contact. The reflector shell 102, ring 104, and panel 106 form a single structural unit. The unit may then be attached to other components via, for example, metallic interfaces such as HRM brackets and boom brackets.

In FIG. 1B, the reflector shell 102, the ring 104, and the panel 106 are similarly mutually attached, but an exploded view is provided to better illustrate further features of the present disclosure.

It will be appreciated that the panel 106 may be attached to or otherwise disposed on a spacecraft (or attached to or otherwise disposed on one or more other components that are themselves attached to or otherwise disposed, directly or indirectly, on the spacecraft).

The ring 104 includes a plurality of diameters. In FIG. 1B, a plurality of outer edges 108 form a first diameter, and a plurality of inner edges 110 form a second diameter. For greater clarity, only one such outer edge 108 and one such inner edge 110 has been labelled in FIG. 1B, but it is to be understood that the ring 104 includes the foregoing pluralities. The first diameter is greater than the second diameter. The first diameter is smaller than a diameter of the reflector shell 102. It is to be understood that the ring 104 is continuous, i.e., even though there are a plurality of outer edges 108 and a plurality of inner edges 110, the ring 104 does not include any breaks or discontinuities of any kind.

In an embodiment, the ring 104 is a spline as shown in FIG. 1B. In such an embodiment, the ring 104 may be referred to as a spline ring or splined ring. In an embodiment, the spline ring may be constructed by deforming a flat sheet of carbon into the spline shape. In an embodiment, the ring 104 or rings 104 may be constructed by bonding sections to form a spline.

The ring 104 may be generally or approximately circular. The ring 104 may be generally or approximately elliptical. The ring 104 may be or may take or may include other rounded shapes.

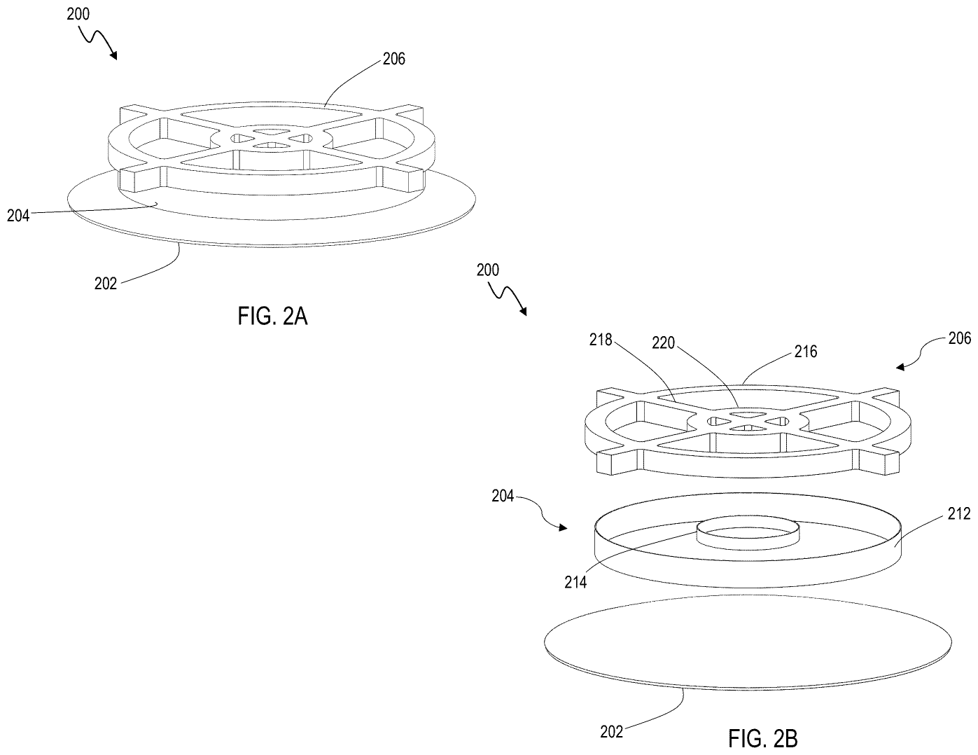

Because the ring 104 includes the plurality of diameters provided by the outer edges 108 and the inner edges 110, the ring 104 advantageously imparts stiffness and stability to the reflector 104 along each of the plurality of diameters. For example, the ring 104 imparts stiffness to the reflector shell 102 at each edge 108 and at each edge 110. A single ring 104 may thus serve as multiple such rings (as shown in FIGS. 2A, 2B), providing greater stiffness and stability with fewer components.

The reflector 100 is a solid-shell reflector. Solid-shell reflectors present numerous advantages over mesh reflectors, such as lower cost, efficient reflection in the Ka band, non-parabolic shaping, and less to no undesirable passive intermodulation (PIM).

The panel 106 is relatively thick compared to the reflector shell 102. The panel 106 may have a thickness of between 2-4 inches. The panel 106 may be relatively flat compared to the reflector shell 102. The panel 106 may have disposed thereon front and/or back face sheets made of the same reflecting material as the shell 102.

The panel 106 may have attached thereto or disposed thereon a plurality of such rings 104, each such ring 104 attached to a single reflector shell 102.

The panel 106 may be attached (indirectly) to a plurality of such reflector shells 102, each such reflector shell 102 having one or more rings 104 disposed between the respective reflector shell 102 and the panel 106.

The ring 104 is continuous. Being continuous imparts stiffness along the entire circumference of the ring 104. In some embodiments, the ring 104 may include small cutouts near the bond. In such cases, the ring 104 may not be entirely continuous (somewhat discontinuous).

The ring 104 may be made of carbon fiber. The ring 104 may be made of epoxy.

The ring 104 may be a sandwich panel (laminates about a honeycomb core).

The ring 104 may be a single component. The single component may be a monolithic laminate.

In an embodiment, the ring 104 may include local reinforcements to increase stiffness and/or strength or to increase or decrease local stiffness or strength in the ring 104. The local reinforcements may be doublers. The local reinforcements may include one or more variations in thickness to provide local thicker and thinner sections.

In some embodiments, the ring 104 is between 1 and 4 inches in height and between 25 and 80 inches in diameter (i.e., at the outer diameter).

In an embodiment, the ring 104 has an outer diameter of approximately 75-80% of the diameter of the reflector shell 102.

The stiffness provided by the ring 104 to the reflector shell 102 may advantageously improve structural and thermal elastic distortion performance, as the plurality of diameters maximizes the coverage of support on the reflector shell 102.

The multiple diameters of the ring 104 advantageously reduce the pocket modes of the reflector shell 102, i.e., areas or ways in which the reflector shell 102 would disadvantageously deform, globally or locally, if a pocket is not adequately stiffened or supported.

In an embodiment, the reflector shell 102 has a relatively bowl-like or curved shape. Such a shape is inherently stiffer than a flatter shape, and so fewer rings 104 or diameters may be provided (e.g., only a single ring 104).

In an embodiment, the reflector shell 102 has a relatively flat shape. Such a shape is inherently less stiff than a bowl-like or curved shape, and so more rings 104 or diameters may be provided (e.g., a plurality of rings 104).

In a preferred embodiment, all components of the reflector 100 share the same materials (and thus the same coefficient of thermal expansion) so as to undergo the same breathing or expansion during thermal loading.

The ring 104 may include one or more cut-out sections (not shown) to increase or decrease local flexibility in the ring 104. Where a plurality of such rings 104 are provided, such cut-out sections may be provided in one or more of such rings 104.

The ring 104 may be attached or bonded to the shell 102 via a continuous bead of structural adhesive. Where the ring 104 is attached to or bonded to the shell 102 may include a multi-curved surface. The structural adhesive is strong enough to transfer a load from the shell 102 to the ring 104 to the panel 106 to a spacecraft. The structural adhesive may be a permanent adhesive.

The adhesive may be applied to an edge of the ring 104. When the ring 104 and the shell 102 are brought together, adhesive may bleed out onto the shell 102, such adhesive being cleared away.

The panel 106 may be similarly attached or bonded to the ring 104 via a continuous bead of the structural adhesive.

The ring 104 may be cut so as to match the (curving) profile of the shell 102 on one side of the ring 104 and the (flat) profile of the panel 106 on the other side of the ring 104. The respective sides of the ring 104 may further be dry-fitted and/or sanded to the shell 102 and the panel 106, respectively, before the structural adhesive is applied.

In particular, the reflector shell 102 may be produced on a mold and may have an idiosyncratic shape. The shape of the reflector shell 102 may be corrected according to desired parameters with the ring 104 dry-fitted to that shape. Accordingly, bonding the ring 104 to the shell 102 corrects and maintains the desired shape. In particular, the ring 104 may correct twisting and clamming. A single ring may not be able to further correct cupping or opening up of the shell 102 (i.e., when a central portion of the shell 102 bows in or out and edges of the shell bow in the opposite direction), but the ring 104 with a plurality of diameters may advantageously further correct cupping or opening up behaviour of the shell 102.

Referring now to FIGS. 2A and 2B, shown therein are a perspective view and a perspective exploded view, respectively, of a reflector 200, according to an embodiment. Like numerals denote like references with respect to FIGS. 1A and 1B. In the interest of clarity, discussion of like features will not be repeated with respect to FIGS. 2A and 2B.

The ring 204 includes an outer band 212 and an inner band 214.

Because the ring 204 includes the plurality of diameters provided by the outer band 212 and the inner band 214, the ring 104 advantageously imparts stiffness and stability to the reflector 202 along each of the plurality of diameters. For example, the ring 204 imparts stiffness to the reflector 202 at each band 212, 214.

The outer band 212 and/or the inner band 214 may each be or include the ring 104 as discussed with respect to FIGS. 1A and 1B. Where the outer band 212 and/or the inner band 214 are or include the ring 104 (e.g., each of the outer band 212 and the inner band 214 is a spline), the plurality of diameters provided by the ring 204 includes more than two such diameters (e.g., four diameters).

Each band of the ring 204 is advantageously continuous in order to impart stiffness to the reflector 202 at each point along the circumference of each of the bands 212, 214 therein.

The panel 216 further includes an outer portion 216, supports 218, and an inner portion 220. Inner portion 220 is used to support the smaller diameter ring (band 214). Supports 218 are used to connect inner portion 220 to outer portion 216. This entire assembly being connected imparts strength and stiffness.

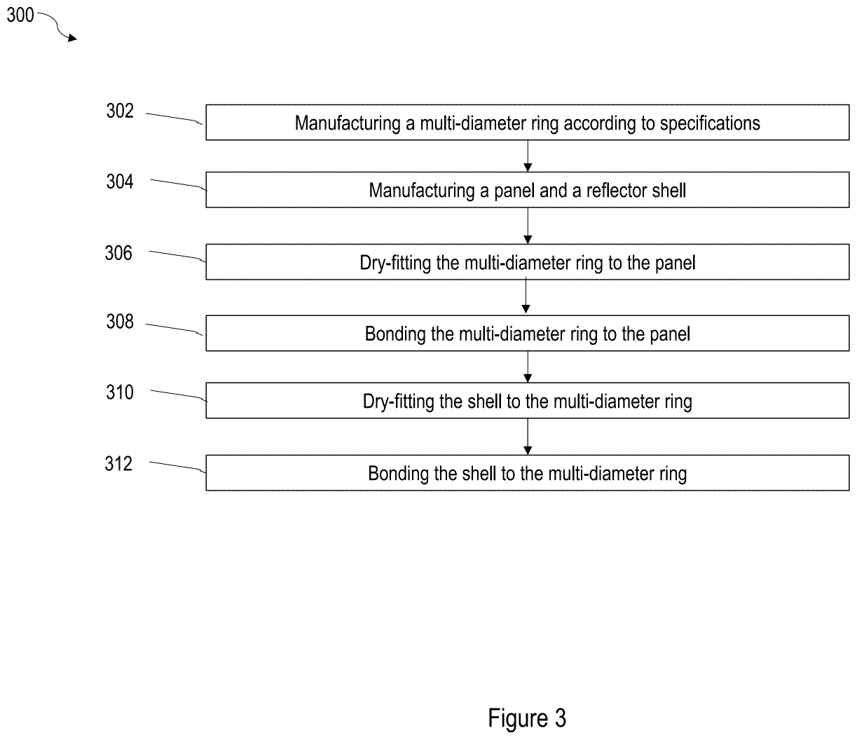

Referring now to FIG. 3, shown therein is a flowchart of a method 300 of assembling a multi-diameter reflector, according to an embodiment. The reflector may be the reflector 100 of FIGS. 1A and 1B.

At 302, the method 300 includes manufacturing a multi-diameter ring according to specifications. The specifications may be defined by tooling. The multi-diameter ring may be the multi-diameter ring 104 of FIGS. 1A-1B.

At 304, the method 300 includes manufacturing a panel and a reflector shell. The panel may be the panel 106 of FIGS. 1A-1B. The reflector shell may be the reflector shell 102 of FIGS. 1A-1B.

At 306, the method 300 includes dry-fitting the ring 104 to the panel 106.

At 308, the method 300 includes bonding the multi-diameter ring to the panel. The bonding may be performed with a structural adhesive.

At 310, the method 300 includes dry-fitting the shell to the multi-diameter ring.

At 312, the method 300 includes bonding the shell to the multi-diameter ring. The bonding may be performed with the structural adhesive.

The structural adhesive is strong enough to transfer a load from the shell to the ring to the panel to a spacecraft. The structural adhesive may be a permanent adhesive.

In some embodiments, though not preferred, the ring may be bonded to the shell first before the panel.

In some embodiments, the ring may be machined to match a curvature of the shell and panel that have previously been measured to closely mechanically mate them.

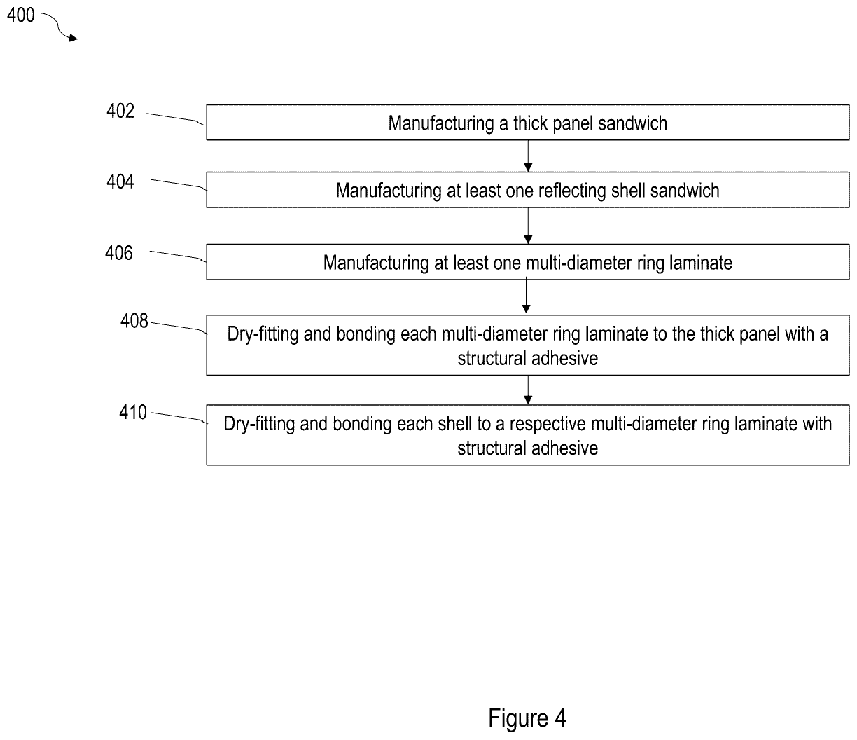

Referring now to FIG. 4, shown therein is a flowchart of a method 400 for assembling a multi-diameter reflector, according to an embodiment. The reflector may be the reflector 100 of FIGS. 1A and 1B.

At 402, the method 400 includes manufacturing a thick panel sandwich. In a preferred embodiment, the thick panel sandwich includes top and bottom carbon-fiber reinforced plastic (CFRP) facesheets with a thickness between 0.040 and 0.060 inches about an aluminum core with a thickness between 2 and 3 inches. The thick panel sandwich may be the panel 106 of FIG. 1.

At 404, the method 400 includes manufacturing at least one reflector shell sandwich. In a preferred embodiment, the at least one reflector shell sandwich includes top and bottom CFRP facesheets with a thickness of approximately 0.010 inches about an aluminum or para-aramid core with a thickness of approximately 0.250 inches. Each reflector shell sandwich may correspond to the reflector shell 102 of FIG. 1.

At 406, the method 400 includes manufacturing at least one multi-diameter ring laminate. In a preferred embodiment, the at least one multi-diameter ring laminate includes a CFRP facesheet with a thickness of approximately 0.040 inches.

The at least one multi-diameter ring laminate may be a single part cured on a mould as a continuous ring.

The at least one multi-diameter ring laminate may be a single assembly formed from flat laminate stock bonded together with a structural adhesive.

The at least one multi-diameter ring laminate may correspond to the multi-diameter ring 104 of FIG. 1.

At 408, the method 400 includes dry-fitting and bonding each multi-diameter ring laminate to the thick panel with a structural adhesive.

At 420, the method 400 includes dry-fitting and bonding each shell to a respective multi-diameter ring laminate with structural adhesive.

1. A multi-diameter reflector comprising:
a reflector shell having a shell diameter;
a multi-diameter ring having first and second opposing edges, the multi-diameter ring being structurally adhered to the reflector shell at the first edge, the multi-diameter ring having an outer diameter less than the shell diameter and an inner diameter less than the outer diameter;
a panel structurally adhered to the multi-diameter ring at the second edge;
wherein the multi-diameter ring has a continuous profile to support structural loads and maintain the reflector shell in a predefined shape.

2. The multi-diameter reflector of claim 1, wherein the multi-diameter ring is a spline.

3. The multi-diameter reflector of claim 1, wherein the multi-diameter ring comprises a plurality of bands.

4. The multi-diameter reflector of claim 3, wherein at least one of the plurality of bands is a spline.

5. The multi-diameter reflector of claim 1, wherein the outer diameter is 75%-85% of the shell diameter.

6. The multi-diameter reflector of claim 1, wherein the ring comprises a plurality of laminates disposed about a honeycomb core, or the ring is a monolithic laminate.

7. The multi-diameter reflector of claim 1, wherein the ring is between 1 and 4 inches in height, and wherein the outer diameter is between 25 and 80 inches in diameter.

8. The multi-diameter reflector of claim 1, wherein the ring includes one or more cut-out sections to increase or decrease local flexibility in the ring.

9. The multi-diameter reflector of claim 1, wherein the ring is structurally adhered to the reflector shell via a continuous bead of permanent adhesive.

10. The multi-diameter reflector of claim 1, wherein the ring includes local reinforcements to increase stiffness or strength, and wherein the local reinforcements comprise one or more variations in thickness to provide local thicker and thinner sections or one or more doublers.

11. A method of assembling a multi-diameter reflector, the reflector including at least one reflector shell sandwich and at least one multi-diameter ring laminate for maintaining stiffness in the at least one reflector shell sandwich, the method comprising:
manufacturing a thick panel sandwich;
manufacturing the at least one reflector shell sandwich;
manufacturing the at least one multi-diameter ring laminate;
defining a desired shape of each multi-diameter ring laminate and maintaining the shape by using tooling;
dry-fitting and bonding each multi-diameter ring laminate to the thick panel with a structural adhesive;
mapping and correcting the shape of the shell to the desired shape by using tooling; and
dry-fitting and bonding each shell to a respective multi-diameter ring laminate with structural adhesive.

12. The method of claim 11, wherein the thick panel sandwich includes top and bottom carbon-fiber reinforced plastic (CFRP) facesheets with a thickness between 0.040 and 0.060 inches about an aluminum core with a thickness between 2 and 3 inches.

13. The method of claim 11, wherein the at least one reflector shell sandwich includes top and bottom CFRP facesheets with a thickness of approximately 0.010 inches about an aluminum or para-aramid core with a thickness of approximately 0.250 inches.

14. The method of claim 11, wherein the at least one multi-diameter ring laminate includes a CFRP facesheet with a thickness of approximately 0.040 inches.

15. The method of claim 11, wherein manufacturing the at least one multi-diameter ring laminate includes curing the at least one multi-diameter ring laminate on a mould as a single continuous ring.

16. The method of claim 11, wherein manufacturing the at least one multi-diameter ring laminate includes forming the at least one multi-diameter ring laminate as a single assembly from flat laminate stock bonded together with a structural adhesive.

17. The method of claim 11, wherein the at least one multi-diameter ring laminate is a spline.

18. The method of claim 11, wherein the at least one multi-diameter ring laminate comprises a plurality of bands.

19. The method of claim 18, wherein at least one of the plurality of bands is a spline.

20. The method of claim 11, wherein the at least one multi-diameter ring laminate includes one or more cut-out sections to increase or decrease local flexibility in the at least one multi-diameter ring laminate or local reinforcements to increase stiffness or strength.
